(19) United States
(12) Patent Application Publication
(10) Pub. No.: US 2016/0359756 A1
(43) Pub. Date: Dec. 8, 2016

(54) COMMUNICATION DEVICE, INTEGRATED CIRCUITRY, AND THE COMMUNICATION METHOD THEREOF

(71) Applicant: MediaTek Inc., Hsin-Chu (TW)

(72) Inventors: Yu-Ju LEE, Miaoli County (TW); Ying-You LIN, Taoyuan City (TW); Chih-Wei KANG, Taipei City (TW); Chih-Kun CHANG, New Taipei City (TW)

(21) Appl. No.: 15/172,287

(22) Filed: Jun. 3, 2016

Related U.S. Application Data
(60) Provisional application No. 62/170,812, filed on Jun. 4, 2015.

(51) Int. Cl. H04L 12/825; H04L 12/853

(52) U.S. Cl. CPC H04L 47/263; H04L 47/2416

(57) ABSTRACT

A communication device for setting a packet-transmission rate for transmitting aggregated-media access-control protocol data unit (A-MPDU) packets is provided. The communication device includes a first processor, a second processor, and a transceiver unit. The first processor transmits an initial rate at each specific period and transmits a hardware indicator. The second processor receives the hardware indicator and transmits a real-time rate, wherein the second processor adjusts the real-time rate according to the hardware indicator. The transceiver unit is coupled to the first processor and the second processor. The transceiver unit receives the initial rate and the real-time rate, wherein the transceiver unit sets the packet-transmission rate according to the initial rate and the real-time rate.

### CROSS REFERENCE TO RELATED APPLICATION

The present application is based on, and claims priority from, U.S. application Ser. No. 62/170,812, filed on Jun. 4, 2015, the invention of which is hereby incorporated by reference herein in its entirety.

### TECHNICAL FIELD

The invention relates to set a packet-transmission rate for transmitting aggregated-media access-control protocol data unit (A-MPDU) packets, and more particularly to set the packet-transmission rate by a hierarchy-guided rate-adaptation system.

### BACKGROUND

Modern Static Random Access Memory (SRAM) equipped in an integrated circuitry has limited memory space for data processing. However, current period-based rate-adaptation mechanisms for network communication need a large memory size to store and process previous data, such as statistic packet-transmission information. In addition, current packet-based rate-adaptation mechanisms for network communication are needed in order to reflect instant transmission variations, such as real-time packet-transmission information. In view of this, the present invention provides a communication device for setting a packet-transmission rate for transmitting aggregated-media access-control protocol data unit (A-MPDU) packets.

### SUMMARY

An embodiment of the present invention provides a communication device for setting a packet-transmission rate. The packet transmission rate can be used for transmitting A-MPDU packets. The communication device comprises a first processor, a second processor, and a transceiver unit. The first processor transmits an initial rate at each specific period and transmits a hardware indicator. The second processor is coupled to the first processor, wherein the second processor receives the hardware indicator and transmits a real-time rate. The second processor adjusts the real-time rate according to the hardware indicator. The transceiver unit is coupled to the first processor and the second processor. The transceiver unit receives the initial rate and the real-time rate. The transceiver unit sets the packet-transmission rate according to the initial rate and the real-time rate.

An embodiment of the present invention provides an integrated circuitry for providing a real-time transmission rate. The integrated circuitry comprises a receiving unit and a processor. The receiving unit receives a hardware indicator from a micro control unit. The processor is coupled to the receiving unit, wherein the processor adjusts the real-time transmission rate according to the hardware indicator.

An embodiment of the present invention provides a communication method for setting a packet-transmission rate. The communication method comprises generating, by a first processor, an initial rate and a hardware indicator; adjusting, by a second processor, a real-time rate according to the hardware indicator; and setting, by a transceiver unit, the packet-transmission rate according to the initial rate and the real-time rate.

### BRIEF DESCRIPTION OF THE DRAWINGS

The present invention can be more fully understood by reading the subsequent detailed description and examples with references made to the accompanying drawings, wherein:

FIG. 1 shows a block diagram of a communication device 10 according to a first embodiment of the present invention.

FIG. 2 shows a block diagram of an integrated circuitry 20 according to a second embodiment of the present invention.

FIG. 3 shows a timeline of transmission behaviors of the communication device 10 according to a third embodiment of the present invention.

FIG. 4 shows a timeline of transmission behaviors of the communication device 10 according to a fourth embodiment of the present invention.

FIG. 5 shows a flow diagram 50 of a communication method according to a fifth embodiment of the present invention.

### DETAILED DESCRIPTION

The following description is of the best-contemplated mode of carrying out the present invention. This description is made for the purpose of illustrating the general principles of the present invention and should not be taken in a limiting sense. The scope of the present invention is best determined by reference to the appended claims.

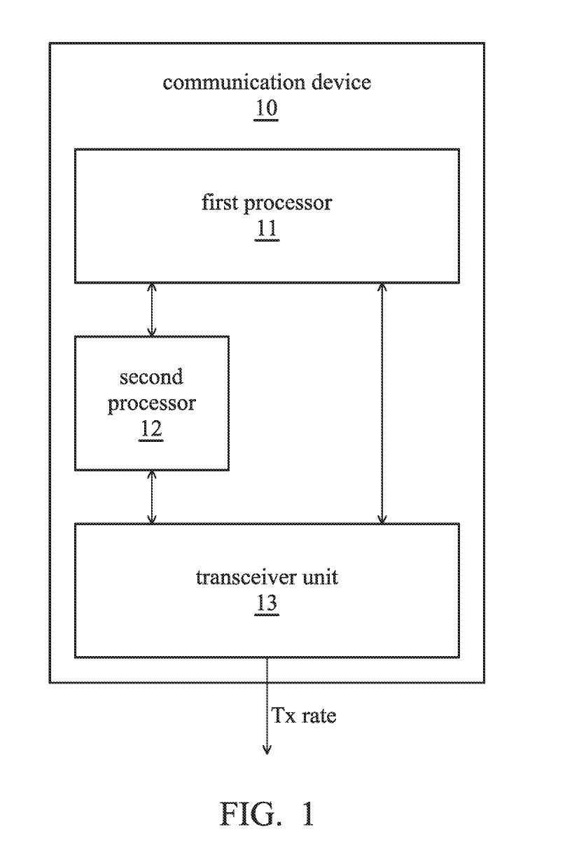

FIG. 1 shows a block diagram of a communication device 10 according to a first embodiment of the present invention. In the first embodiment, the communication device 10 is used for setting a packet-transmission rate (Tx rate), such as a packet transmission rate for transmitting A-MPDU packets to a physical layer. The communication device 10 comprises a first processor 11, a second processor 12, and a transceiver unit 13. The first processor 11 is coupled to the second processor 12. The transceiver unit is coupled to the first processor 11 and the second processor 13. In the first embodiment, the communication device 10 is an access point (AP), the first processor 11 can be implemented by a micro control unit of the AP or a host terminal of the AP, and the second processor 12 can be implemented by a hardware logic circuit of an integrated circuitry, such as a Netcom chip, of the AP, but the present invention is not limited thereto.

In the first embodiment, the first processor 11 transmits an initial rate to the transceiver unit 13 at each specific period, and the first processor 11 also transmits a hardware indicator to the second processor 12. For example, the first processor 11 sets a new initial rate according to a period-based rate-adaptation algorithm and then transmits the new initial rate to the transceiver unit 13 per 100 milliseconds. Accordingly, the initial rate is unchanged during the specific period. In the first embodiment, the first processor 11 uses the real-time rate and the hardware indicator to adjust the initial rate. In addition, the initial rate is also adjusted according to statistics packet-transmission information such as number of statistics packet-transmission failures, number of statistics packet-transmission successes, or number of statistics packet retry times. In addition, the statistics packet-transmission information also comprises signal processing information such as Signal-to-Noise Ratio (SNR) or signal intensity information such as Receive Signal Strength Indication (RSSI).

In the first embodiment, the second processor 12 receives the hardware indicator, and reflects to transmit a real-time rate to the transceiver unit 13, wherein the second processor 12 adjusts the real-time rate according to the hardware indicator. For example, the hardware indicator prompts the second processor 12 to choose a corresponding algorithm run by the hardware logic circuit of the second processor 12, wherein the corresponding algorithm can be a packet-based rate-adaptation algorithm. Then the second processor 12 uses the packet-based rate-adaptation algorithm to generate the real-time rate of corresponding transmitted A-MPDU/MPDU packets. In the first embodiment, the second processor 12 also reports the results of the corresponding algorithm to the first processor 11 so that the first processor 11 can adjust the hardware indicator according to the results.

In the first embodiment, the real-time rate is also adjusted/reflected by real-time packet-transmission information such as number of real-time packet-transmission failures, number of real-time packet-transmission successes, and number of real-time packet retry times. Accordingly, the real-time rate changes with each transmitted A-MPDU/MPDU packet. For example, if the real-time packet-transmission information shows that the number of real-time packet-transmission failures increases, the second processor 12 lowers the real-time rate accordingly. For example, if the real-time packet-transmission information shows that the number of real-time packet-transmission retry times decreases, the second processor 12 raises the real-time rate accordingly.

In the first embodiment, the transceiver unit 13 receives the initial rate and the real-time rate, and thereby sets the packet-transmission rate according to the initial rate and the real-time rate. The transceiver unit 13 feeds back or reports the statistics packet-transmission information to the first processor 11, and the transceiver unit 13 also feeds back/reports the real-time packet-transmission information to the first processor 12.

In the first embodiment, if the transceiver unit 13 starts to transmit a new A-MPDU/MPDU packet, the transceiver unit 13 sets the packet-transmission rate of the new A-MPDU/MPDU packet according to the initial rate. Then, if the transceiver unit 13 needs to retransmit the new A-MPDU/MPDU packet, the transceiver unit 13 sets the packet-transmission rate of the new A-MPDU/MPDU packet according to the initial rate and the real-time rate. In the first embodiment, the statistics packet-transmission information can be stored in an SRAM of the first processor 11.

In the first embodiment, the first processor 11 can be considered as an upper module, and the second processor 12 can be considered as a lower module, wherein the upper module guides the initial rate for the packet-transmission rate in each specific period, and the lower module adjusts the packet-transmission rate based on the above initial rate. Because only the upper module can receive the statistics packet-transmission information whereas the lower module cannot, the upper module uses the hardware indicator to append or compensate for the real-time rate generated by the lower module. Accordingly, the real-time rate generated by the lower module is also reflected by some long-term transmission conditions, such as the statistics packet-transmission information. In addition, it is worth noting that the lower module can indirectly consider some long-term transmission conditions without an additional memory space for storing the statistics packet-transmission information. For the upper module, the initial rate of the packet-transmission rate can be determined by a period-based rate-adaptation algorithm. For the lower module, the real-time rate of the packet-transmission rate can be determined by a packet-based rate-adaptation algorithm. Finally, by implementing the upper module and the lower module, the communication 10 can be considered as a hierarchy-guided rate-adaptation system. In the first embodiment, the hierarchy-guided rate-adaptation system can simultaneously consider long-term (per period) and short-term (per packet) rate-adaptation issues without accessing too much memory space for storing real-time and statistic packet-transmission information. Hence the hierarchy-guided rate-adaptation system can solve rate-adaptation issues with limited memory space and can be implemented in some current communication devices such as a notebook equipped with an integrated circuitry or an AP equipped with an integrated circuitry, such as a Netcom chip.

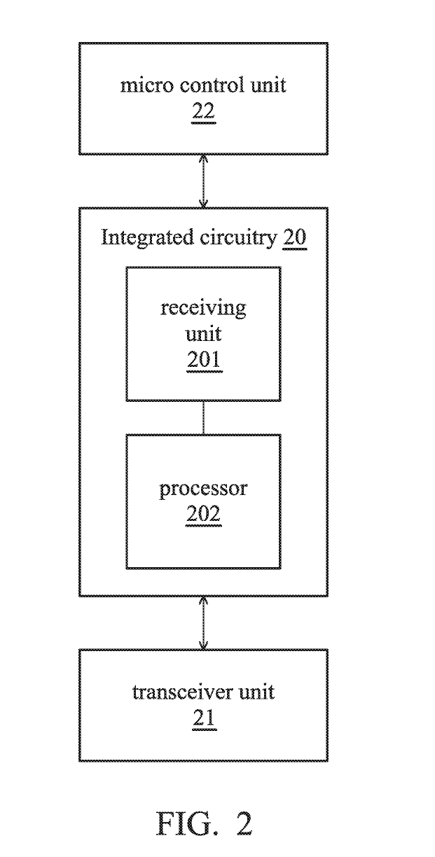

FIG. 2 shows a block diagram of an integrated circuitry 20 according to a second embodiment of the present invention. In the second embodiment, the integrated circuitry 20 is used for providing a real-time transmission rate for transmitting A-MPDU packets to a transceiver unit 21 of a media access control (MAC) layer. In the second embodiment, the integrated circuitry 20 comprises a receiving unit 201 and a processor 202. The receiving unit 201 receives a hardware indicator from a micro control unit 22, wherein the hardware indicator is used to indicate the integrated circuitry 20 to perform which packet-based rate-adaptation algorithm. The processor 202 is coupled to the receiving unit 201, wherein the processor 202 adjusts the real-time transmission rate according to the hardware indicator.

In the second embodiment, the receiving unit 201 further receives real-time packet-transmission information from the transceiver unit 201. Then the processor 202 adjusts the real-time transmission rate according to the hardware indicator and the real-time packet-transmission information. In the second embodiment, the real-time rate is also adjusted/reflected by the real-time packet-transmission information, such as number of real-time packet-transmission failures, number of real-time packet-transmission successes, and number of real-time packet retry times. Accordingly, the real-time rate changes with each transmitted A-MPDU/MPDU packet.

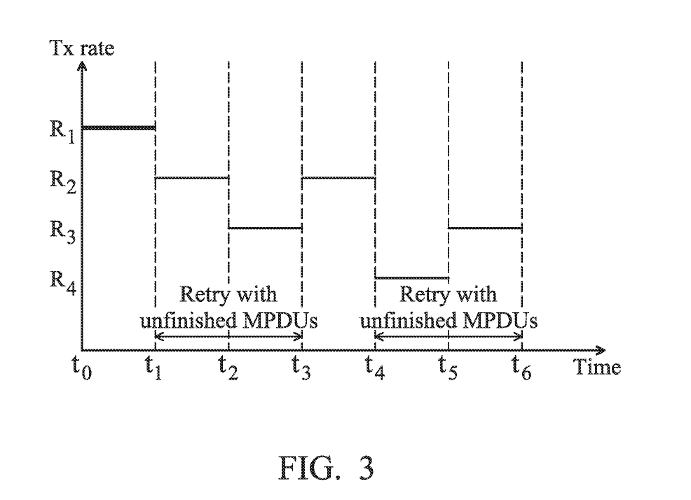

FIG. 3 shows a timeline of transmission behaviors of the communication device 10 according to a third embodiment of the present invention. In the third embodiment, the x-axis represents time, and the y-axis represents the packet-transmission rate (Tx rate) of the communication device 10. Referring to FIG. 3, during the time period of t₀-t₁, the transceiver unit 13 sets a packet-transmission rate R₁ of a new A-MPDU packet according to an initial rate guided by the first processor 11. The second processor 12 simultaneously receives the real-time packet-transmission information from the transceiver unit 13. At this time, the second processor 12 knows some MPDU packets (sub-frames) of the new A-MPDU packet-transmission have failed, and thereby transmits a corresponding real-time rate to the transceiver unit 13 according to the initial rate R₁ and a first hardware indicator received from the first processor 11.

Then, in the third embodiment, during the time period of t₁-t₂, the transceiver unit 13 adjusts the packet-transmission rate from R₁ to R₂ according to the corresponding real-time rate, and reports the number of MPDU packets transmission failures of the new A-MPDU packet (i.e. the number of sub-frame transmission failures of the A-MPDU packet) to the second processor 12. For example, if the new A-MPDU packet comprises 256 MPDU packets (sub-frames), the transceiver unit 13 reports to the second processor 12 that 120 MPDU packets (sub-frames) of the new A-MPDU packet fail to transmit to the physical layer. The second processor 12 transmits the next corresponding real-time rate to the transceiver unit 13 thereby. Then, during the time period of t₂-t₃, the transceiver unit 13 adjusts the packet-transmission rate from R₂ to R₃ according to the next corresponding real-time rate, and reports transmission success to the second processor 12. In addition, during the time period of t₂-t₃, the first processor 11 transmits the next initial rate R₂ to the transceiver unit 13, and the first processor 11 transmits a second hardware indicator to the second processor 12. In other words, the first processor 11 meets the specific period during the time period of t₂-t₃. In addition, in the third embodiment, during the time period of t₁-t₃, the transceiver unit 13 performs to retry with unfinished MPDU packets.

In the third embodiment, during the time period of t₃-t₄, the transceiver unit 13 sets a packet-transmission rate R₂ of another A-MPDU packet according to an next initial rate R₂ guided by the first processor 11. At this time, the second processor 12 knows some MPDU packets (sub-frames) of the A-MPDU packet-transmission have failed, and thereby transmits a corresponding real-time rate to the transceiver unit 13 according to the initial rate R₂ and the second hardware indicator received from the first processor 11. Then, during the time period of t₄-t₅, the transceiver unit 13 adjusts the packet-transmission rate from R₂ to R₄ according to the corresponding real-time rate, and reports some MPDU packets (sub-frames) of the A-MPDU packet-transmission failures to the second processor 12. The second processor 12 transmits the next corresponding real-time rate to the transceiver unit 13 thereby. Then, during the time period of t₅-t₆, the transceiver unit 13 adjusts the packet-transmission rate from R₄ to R₃ according to the next corresponding real-time rate, and reports transmission success to the second processor 12. In addition, in the third embodiment, during the time period of t₄-t₆, the transceiver unit 13 performs to retry with unfinished MPDU packets.

In the third embodiment, it is worth noting that the transceiver unit 13 feeds back statistics packet-transmission information to the first processor 11. For example, the transceiver unit 13 feeds back the total number of retry times with transmitting 1000 A-MPDU packets to the first processor 11 or feeds back how many MPDU packets (sub-frames) transmission fails with transmitting 1000 A-MPDU packets to the first processor 11. For example, the transceiver unit 13 also feeds back SNR information and RSSI information to the first processor 11 for wireless communication standard IEEE 802.11n.

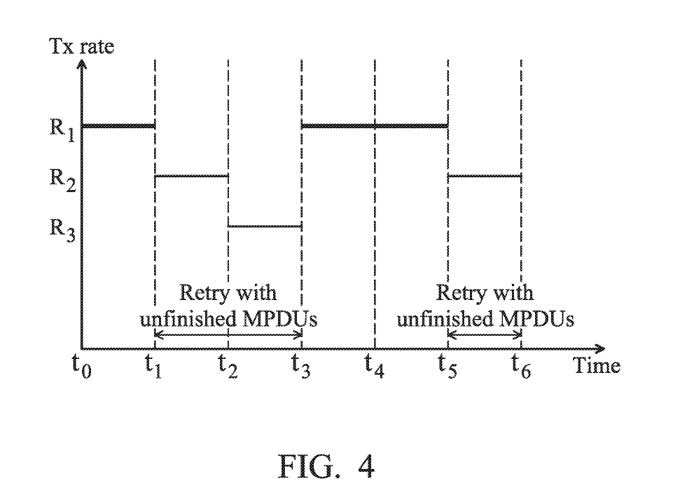

FIG. 4 shows a timeline of transmission behaviors of the communication device 10 according to a fourth embodiment of the present invention. In the fourth embodiment, the x-axis represents time, and the y-axis represents the packet-transmission rate of the communication device 10. Referring to FIG. 4, during the time period of t₀-t₁, the transceiver unit 13 sets a packet-transmission rate R₁ of a new A-MPDU packet according to an initial rate guided by the first processor 11. The second processor 12 simultaneously receives the real-time packet-transmission information from the transceiver unit 13. At this time, the second processor 12 knows some MPDU packets (sub-frames) of the new A-MPDU packet-transmission have failed, and thereby transmits a corresponding real-time rate to the transceiver unit 13 according to the initial rate R₁ and a first hardware indicator received from the first processor 11.

Then, in the fourth embodiment, during the time period of t₁-t₂, the transceiver unit 13 adjusts the packet-transmission rate from R₁ to R₂ according to the corresponding real-time rate, and reports some MPDU packets (sub-frames) of the new A-MPDU packet-transmission failures to the second processor 12. The second processor 12 transmits the next corresponding real-time rate to the transceiver unit 13 thereby. Then, during the time period of t₂-t₃, the transceiver unit 13 adjusts the packet-transmission rate from R₂ to R₃ according to the next corresponding real-time rate, and reports transmission success to the second processor 12. The difference between the third embodiment and the fourth embodiment is that, in the fourth embodiment, the first processor 11 does not transmit the next initial rate R₂ to the transceiver unit 13, and also does not transmit a second hardware indicator to the second processor 12 during the time period of t₂-t₃. In other words, the first processor 11 does not meet the specific period during the time period of t₂-t₃.

Then, in the fourth embodiment, during the time period of t₃-t₄, the transceiver unit 13 sets the packet-transmission rate R₁ of another A-MPDU packet according to the same initial rate guided by the first processor 11. The second processor 12 simultaneously receives the real-time packet-transmission information from the transceiver unit 13. At this time, the second processor 12 knows the A-MPDU packet-transmission successes from the real-time packet-transmission information. Then, during the time period of t₄-t₅, the transceiver unit 13 sets the packet-transmission rate R₁ of another A-MPDU packet according to the same initial rate guided by the first processor 11. At this time, the second processor 12 knows some MPDU packets (sub-frames) of the current A-MPDU packet-transmission have failed, and thereby transmits a corresponding real-time rate to the transceiver unit 13 according to the initial rate R₁ and a first hardware indicator received. from the first processor 11. Then, during the time period of t₅-t₆, the transceiver unit 13 adjusts the packet-transmission rate from R₁ to R₂ according to the corresponding real-time rate, and reports transmission success to the second processor 12.

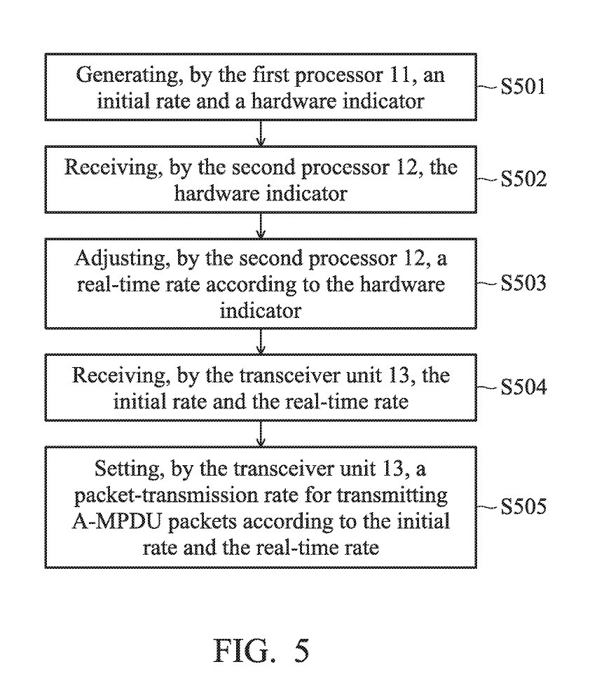

FIG. 5 shows a flow diagram 50 of a communication method according to a fifth embodiment of the present invention, In step S501, the first processor 11 generates an initial rate and a hardware indicator. In step S502, the second processor 12 receives the hardware indicator. In step S503, the second processor 12 adjusts a real-time rate according to the hardware indicator. In step S504, the transceiver unit 13 receives the initial rate and the real-time rate. In step S505, the transceiver unit 13 sets a packet-transmission rate for transmitting A-MPDU packets according to the initial rate and the real-time rate.

The foregoing outlines features of several embodiments so that those skilled in the art may better understand the aspects of the present invention. Those skilled in the art should appreciate that they may readily use the present invention as a basis for designing or modifying other processes and structures for carrying out the same purposes and/or achieving the same advantages of the embodiments introduced herein. Those skilled in the art should also realize that such equivalent constructions do not depart from the spirit and scope of the present invention, and that they may make various changes, substitutions, and alterations herein without departing from the spirit and scope of the present invention.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the invention has been shown and described with respect to one or more implementations, equivalent alterations and modifications will occur to others skilled in the art based upon a reading and understanding of this specification and the annexed drawings. The invention comprises all such modifications and alterations and is limited only by the scope of the following claims. In particular with regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the invention may have been disclosed with respect to only one of several implementations, such a feature may be combined with one or more other features of the other implementations as may be desired and advantageous for any given or particular application.

What is claimed is:

1. A communication device for setting a packet-transmission, the communication device comprising:
a first processor, for transmitting an initial rate at each specific period and transmitting a hardware indicator;
a second processor, coupled to the first processor, wherein the second processor receives the hardware indicator and transmits a real-time rate; and wherein the second processor adjusts the real-time rate according to the hardware indicator; and
a transceiver unit, coupled to the first processor and the second processor, for receiving the initial rate and the real-time rate, wherein the transceiver unit sets the packet-transmission rate according to the initial rate and the real-time rate.

2. The communication device of claim 1, wherein the transceiver unit further feeds back real-time packet-transmission information to the second processor; and
wherein the second processor adjusts the real-time rate according to the hardware indicator and the real-time packet-transmission information.

3. The communication device of claim 2, wherein the transceiver unit further feeds back statistics packet-transmission information to the first processor; and
wherein the first processor adjusts the initial rate and the hardware indicator according to the statistics packet-transmission information.

4. The communication device of claim 2, wherein the real-time packet-transmission information comprises number of real-time packet-transmission failures, number of real-time packet-transmission successes, and number of real-time packet retry times.

5. The communication device of claim 3, wherein the statistics packet-transmission information comprises number of statistics packet-transmission failures, number of statistics packet-transmission successes, and number of statistics packet retry times.

6. The communication device of claim 1, wherein when the transceiver unit starts to transmit a new packet, the transceiver unit sets the packet-transmission rate of the new packet according to the initial rate.

7. The communication device of claim 6, wherein when the transceiver unit needs to retransmit the new packet, the transceiver unit sets the packet-transmission rate of the new packet according to the initial rate and the real-time rate.

8. The communication device of claim 1, wherein the first processor further adjusts the initial rate according to the real-time rate and the hardware indicator.

9. An integrated circuitry for providing a real-time transmission, the integrated circuitry comprises:
a receiving unit, for receiving a hardware indicator from a micro control unit; and
a processor, coupled to the receiving unit, wherein the processor adjusts the real-time transmission rate according to the hardware indicator.

10. The integrated circuitry of claim 9, wherein the receiving unit further receives real-time packet-transmission information from the transceiver unit; and
wherein the processor adjusts the real-time transmission rate according to the hardware indicator and the real-time packet-transmission information.

11. The integrated circuitry of claim 10, wherein the real-time packet-transmission information comprises number of real-time packet-transmission failures, number of real-time packet-transmission successes, and number of real-time packet retry times.

12. A communication method for setting a packet-transmission rate, the communication method comprises:
generating, by a first processor, an initial rate and a hardware indicator;
adjusting, by a second processor, a real-time rate according to the hardware indicator; and
setting, by a transceiver unit, the packet-transmission rate according to the initial rate and the real-time rate.

13. The communication method of claim 12, further comprising:
receiving, by the second processor, real-time packet-transmission information from the transceiver unit; and
adjusting, by the second processor, the real-time rate according to the hardware indicator and the real-time packet-transmission information.

14. The communication method of claim 13, further comprising:
receiving, by the first processor, statistics packet-transmission information from the transceiver unit; and
adjusting, by the first processor, the initial rate and the hardware indicator according to the statistics packet-transmission information.

15. The communication method of claim 12, wherein the real-time packet-transmission information comprises number of real-time packet-transmission failures, number of real-time packet-transmission successes, and number of real-time packet retry times.

16. The communication method of claim 13, wherein the statistics packet-transmission information comprises number of statistics packet-transmission failures, number of statistics packet-transmission successes, and number of statistics packet retry times.

17. The communication method of claim 12, further comprising:
setting, by the transceiver unit, the packet-transmission rate of a new packet according to the initial rate while starting to transmit the new packet.

18. The communication method of claim 17, further comprising:
setting, by the transceiver unit, the packet-transmission rate of the new packet according to the initial rate while retransmitting the new packet.

19. The communication method of claim 12, further comprising:
adjusting, by the first processor, the initial rate according to the real-time rate and the hardware indicator.
